(19) United States
(12) Patent Application Publication
(10) Pub. No.: US 2019/0266425 A1
(43) Pub. Date: Aug. 29, 2019

(54) IDENTIFICATION APPARATUS, IDENTIFICATION METHOD, AND NON-TRANSITORY TANGIBLE RECORDING MEDIUM STORING IDENTIFICATION PROGRAM

(71) Applicant: PANASONIC INTELLECTUAL PROPERTY MANAGEMENT CO., LTD., Osaka (JP)

(72) Inventors: Hiroshi IWAI, Osaka (JP); Koji ARATA, Kanagawa (JP); Osamu SHIBATA, Hyogo (JP); Tetsuro OKUYAMA, Osaka (JP)

(73) Assignee: PANASONIC INTELLECTUAL PROPERTY MANAGEMENT CO., LTD., Osaka (JP)

(21) Appl. No.: 16/283,217

(22) Filed: Feb. 22, 2019

(30) Foreign Application Priority Data
Feb. 26, 2018 (JP) 2018-031789

(51) Int. Cl. G06K 9/00; G06T 7/73; G06T 7/50

(52) U.S. Cl. CPC G06K 9/00845; G06T 7/74; G06T 7/50; G06T 2207/30268; G06T 2207/20081; G06T 2207/30196; G06T 2207/10048

(57) ABSTRACT

In order to accurately identify a posture of an occupant of a moving object, identification apparatus which identifies the posture of the occupant of the moving object includes distance measurer that determines a feature point of the occupant based on an infrared image or a distance image each obtained by imaging apparatus and derives a distance to the feature point by using a time of flight distance measurement method, and identifier that identifies the posture of the occupant based on the distances to a plurality of the feature points.

### TECHNICAL FIELD

The present invention relates to an identification apparatus, an identification method, and a non-transitory tangible recording medium storing an identification program.

### BACKGROUND ART

Conventionally, there is a known technology of detecting locations of feature points of the hand, the elbow, and the shoulder of an occupant in a moving object from an image captured by a camera, and comparing the locations with previously prepared joint models, thereby identifying a posture of the occupant (PTL 1).

### CITATION LIST

### Patent Literature

PTL 1

Japanese Patent Application Laid-Open No. 2010-211705

### SUMMARY OF INVENTION

### Technical Problem

However, in PTL 1, since the posture of the occupant is identified based on a two-dimensional image captured by a monocular camera, an identification accuracy is improved.

An object of the present disclosure is to accurately identify a posture of an occupant in a moving object.

### Solution to Problem

One aspect of the present distance identification apparatus that identifies a posture of an occupant of a moving object, the identification apparatus including: a distance measurer that determines a feature point of the occupant based on an infrared image or a distance image each obtained by an imaging apparatus, and derives a distance to the feature point by using a time of flight distance measurement method; and an identifier that identifies the posture of the occupant based on the distances to a plurality of the feature points.

One aspect of the present disclosure may be any one of a method and a non-transitory tangible recording medium storing a program.

### Advantageous Effects of Invention

According to the present disclosure, it is possible to accurately identify a posture of an occupant in a moving object.

### BRIEF DESCRIPTION OF DRAWINGS

FIG. 1 is a block diagram illustrating a configuration of a driver monitoring system in which an identification apparatus according to an embodiment of the present disclosure is mounted;

FIG. 2 is a schematic diagram illustrating states of emission light and return light;

FIG. 3 is a flowchart illustrating Embodiment 1 of distance measurement processing and identification processing;

FIG. 4 is a flowchart illustrating an example of the distance measurement processing;

FIG. 5 is a schematic diagram illustrating an outline of a time of flight distance measurement method;

FIG. 6 is a flowchart illustrating another example of the distance measurement processing;

FIG. 7A is a schematic diagram illustrating a distance image of an internal space of a vehicle captured by an imaging apparatus;

FIG. 7B is a diagram illustrating a state in which a site division of a driver is performed;

FIG. 7C is a diagram illustrating a state in which feature points are given;

FIG. 7D is a schematic diagram illustrating derivation of a distance to the feature point;

FIG. 7E is a schematic diagram illustrating the derivation of the distance to the feature point;

FIG. 7F is a schematic diagram illustrating the derivation of the distance to the feature point;

FIG. 7G is a schematic diagram illustrating three-dimensional coordinates of the feature points;

FIG. 7H is a schematic diagram illustrating the three-dimensional coordinates of the feature points in a basic posture;

FIG. 8 is a flowchart illustrating Embodiment 1 of the distance measurement processing and the identification processing;

FIG. 9A is a schematic diagram illustrating a distance image in the internal space of the vehicle captured by the imaging apparatus;

FIG. 99 is a diagram illustrating a state in which the image is cut; and

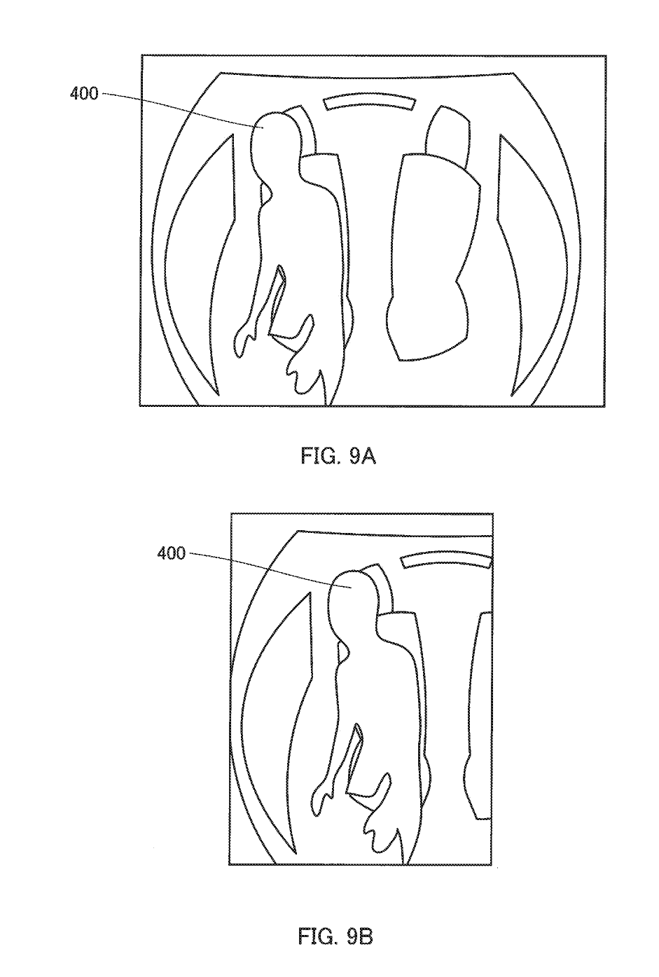

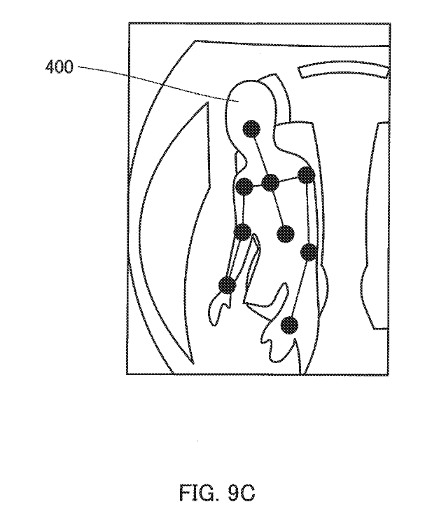

FIG. 9C is a diagram illustrating a state in which the feature points are given.

### DESCRIPTION OF EMBODIMENTS

Hereinafter, driver monitoring system (hereinafter, referred to as “DMS”) 1 in which identification apparatus 100 according to an embodiment of the present disclosure is mounted will be described in detail with reference to the drawings. The embodiment described below is an example, and the present disclosure is not limited by the present embodiment.

DMS 1 is mounted on, for example, a vehicle. Hereinafter, DMS 1 will be described as an apparatus for monitoring a driver of a vehicle, but may monitor other than the driver (for example, an occupant seated in a passenger seat, a rear seat, or the like).

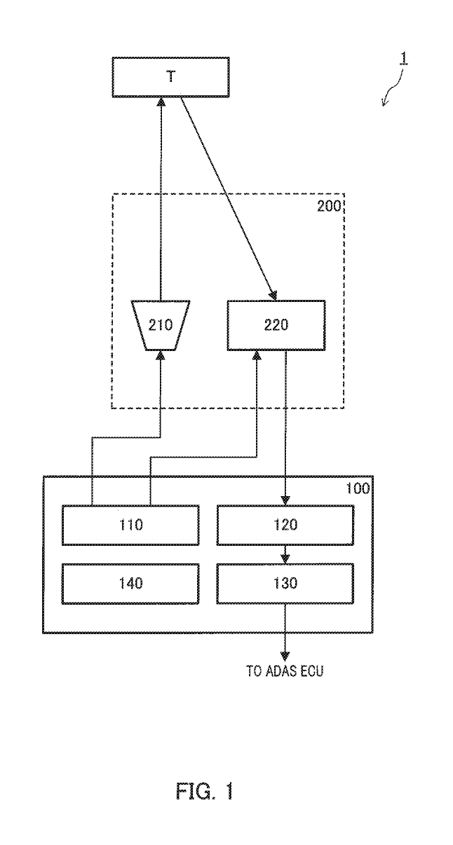

As illustrated in FIG. 1, DMS 1 includes imaging apparatus 200 in which light source 210 and image sensor 220 are integrated, and identification apparatus 100.

Imaging apparatus 200 is one compact camera, that acquires an image of an internal space of a vehicle, and is attached to a ceiling of the vehicle so as to be able to capture an image of the internal space of the vehicle, particularly, to capture the front of a body of a driver in the internal space of the vehicle.

Light source 210 is attached so as to be able to emit invisible light (for example, infrared light or near infrared light) having a cycle such as a pulse or a sinusoidal wave toward an imaging range.

Image sensor 220 is, for example, a complementary metal oxide semiconductor (CMOS) image sensor, and is attached to substantially the same place as light source 210.

Identification apparatus 100 is, for example, an electronic control unit (ECU) and includes an input terminal, an output terminal, a processor, a program memory, and a main memory which are mounted on a control substrate so as to identify a posture and a motion of the driver in the vehicle.

The processor executes a program stored in the program memory by using the main memory to process various signals received via the input terminal and outputs various control signals to light source 210 and image sensor 220 via the output terminal.

As the processor executes the program, identification apparatus 100 functions as imaging controller 110, distance measurer 120, identifier 130, storage section 140, and the like as illustrated in FIG. 1.

Imaging controller 110 outputs a control signal to light source 210 so as to control various conditions (specifically, a pulse width, a pulse amplitude, a pulse interval, the number of pulses, and the like) of the light emitted from light source 210.

In order to control the various conditions (specifically, exposure time, exposure timing, the number of exposure times, and the like) of the return light received by image sensor 220, imaging controller 110 outputs a control signal to surrounding circuits included in image sensor 220.

Image sensor 220 outputs an infrared image signal and a depth image signal relating to the imaging range to identification apparatus 100 at a predetermined cycle (predetermined frame rate) under an exposure control or the like. A visible image signal may be output from image sensor 220.

In addition, in the present embodiment, image sensor 220 performs a so-called lattice transformation of adding information of a plurality of adjacent pixels to generate image information. However, in the present disclosure, it is not indispensable to generate the image information by adding information of the plurality of adjacent pixels.

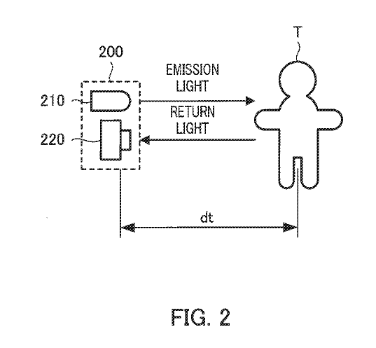

Distance measurer 120 estimates a feature point of a driver from the image output from image sensor 220 and derives a distance to the feature point by using a TOF method. FIG. 2 is a schematic diagram illustrating states of emission light and return light at the time of deriving distance dt to target T.

Identifier 130 calculates coordinates of the feature point based on the distance to the feature point derived by distance measurer 120 and identifies a posture of the driver based on the calculated coordinates of the feature point. The calculation of the coordinates of the feature point may be performed by distance measurer 120.

Storage section 140 stores various kinds of information used in distance measurement processing and identification processing.

Information on a posture and a motion of the driver is output from DMS 1. The information is transmitted to, for example, an advanced driver assistance system (ADAS) ECU. The ADAS ECU performs an automatic operation of the vehicle and a release of the automatic operation by using the information.

### Embodiment 1

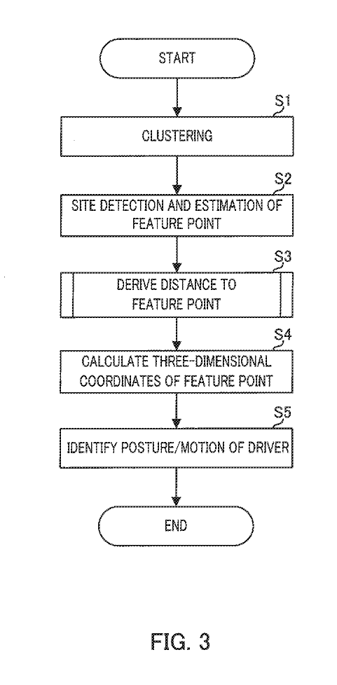

Embodiment 1 of the distance measurement processing and the identification processing performed in distance measurer 120 and identifier 130 of identification apparatus 100 will be described in detail with reference to the flowchart of FIG. 3.

In step S1, distance measurer 120 extracts a region corresponding to a driver using an infrared image or a distance image received from image sensor 220, and clusters the region. Extracting the region corresponding to the driver can be performed, for example, by extracting a region where a distance from an imager is substantially constant.

In subsequent step S2, distance measurer 120 performs a site detection of respective sites (a head part, a body part, an arm part, and a lower body part) of the driver by using the image clustered in step S1, and estimates feature points of a skeleton location and the like according to a preset rules, for the respective sites. In this step, it is also possible to estimate the feature points without performing the site detection.

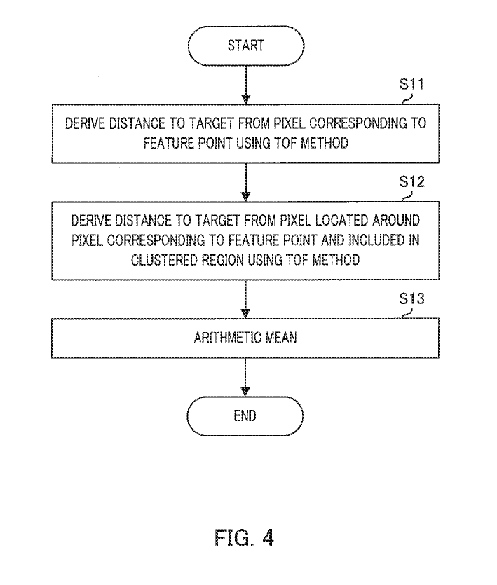

In subsequent step S3, distance measurer 120 derives a distance to each feature point by using the TOF method. An example of processing of deriving the distance to the feature point (distance measurement processing) performed in step S3 will be described in detail with reference to the flowchart of FIG. 4.

First, in step S11, distance measurer 120 derives a distance to a target from a pixel corresponding to the feature point by using the TOF method.

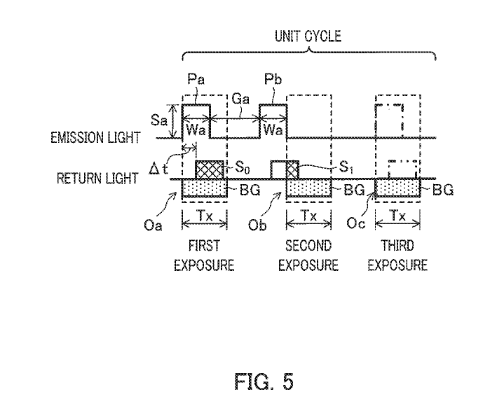

Here, an example of a distance measurement made by the TOF method will be described. As illustrated in FIG. 5, light emission from light source 210 includes at least one pair of first pulse Pa and second pulse Pb during a unit cycle. The pulse interval (that is, time from a failing edge of first pulse Pa to a rising edge of second pulse Pb) is Ga. In addition, amplitudes of the pulses are equal to each other as Sa, and pulse widths thereof are equal to each other and are set to Wa.

Image sensor 220 is controlled by imaging controller 110 so as to be exposed at timing based on emission timing of first pulse Pa and second pulse Pb. Specifically, as illustrated in FIG. 5, image sensor 220 performs a first exposure, a second exposure, and a third exposure for the invisible light obtained by reflecting and returning the light emitted from light source 210 from target T in an imaging range.

The first exposure starts simultaneously with rising of first pulse Pa and ends after preset exposure time Tx in relation to the light emitted from light source 210. The first exposure aims to receive a return light component for first pulse Pa.

Output Oa of image sensor 220 due to the first exposure includes return light component S₀ hatched in a diagonal lattice form and background component BG hatched with dots. An amplitude of return light component S₀ is smaller than an amplitude of first pulse Pa.

Here, a time difference between a rising edge of first pulse Pa and a rising edge of return light component S₀ is referred to as Δt. Δt is time required for the invisible light to reciprocate distance dt from imaging apparatus 200 to target T.

The second exposure starts simultaneously with falling of second pulse Pb and ends after exposure time Tx. The second exposure aims to receive a return light component for second pulse Pb.

Output Ob of image sensor 220 due to the second exposure includes partial return light component S₁ (refer to a hatched portion of the diagonal lattice form) not the entire return light component and background component BG hatched with dots.

Above-described component S₁ can be represented by following equation 1.

S₁=S₀×(Δt/Wa) (1)

The third exposure starts at timing in which the return light components of first pulse Pa and second pulse Pb are not included and ends after exposure time Tx. The third exposure is intended to receive only background component BG which is an invisible light component not relating to the return light components.

Output Oc of image sensor 220 due to the third exposure includes only background component BG hatched with dots.

From a relationship between the emission light and the return light as described above, distance dt from imaging apparatus 200 to a road surface can be derived by following equations 2 to 4.

S₀=Oa−BG (2)

S₁=Ob−BG (3)

dt=c×(Δt/2)={(C×Wa)/2}×(Δt/Wa)={(c×Wa)/2}×(S₁/S₀) (4)

Here, c is a speed of light.

Returning to the description of FIG. 4, in step S12 subsequent to step S11, distance measurer 120 derives a distance from a pixel which is located around the pixel corresponding to the feature point and is included in the clustered region to the target by using the TOF method. The TOF method described in the present embodiment is merely an example, and it is needless to say that distance information can be derived by using any of a direct TOF method of directly performing a measurement in a time domain and an indirect TOF method of performing a measurement by using a change in physical quantity such as a phase difference and a time reference for converting the change in physical quantity into a temporal change.

In step S13 subsequent to step S12, distance measurer 120 performs an arithmetic mean of the distances derived in step S11 and the distance derived in step S12 to output as a distance to the feature point.

As such, when the distance to the feature point is derived, it is possible to improve an accuracy in measuring a distance to the feature point by using information of the pixel corresponding to the feature point and information of the pixel located around the pixel corresponding to the feature point.

In addition, by using only the information of pixels included in the clustered region among the pixels located around the pixel corresponding to the feature point for an arithmetic mean, information of a region which is not included in the sites of a human body can be excluded, and the accuracy in measuring a distance to the feature point can be improved even in the periphery of the feature point. For example, as a partial return light component exceeding a predetermined range with respect to S₁ in the feature point is excluded as the return light from the target not included in the clustered region, such as a sheet, an interior, or the like, it is expected that the accuracy in measuring the distance to the feature point is improved. In addition, in a case where the amount of change of two-dimensional coordinates (X, Y) of the feature point with respect to the past frame is small, the same effect can also be expected by excluding a portion beyond the predetermined range with respect to the feature point S₁ of the feature point in the past frame. The predetermined range is preferably set to a standard deviation of S₁ in the feature point, but the predetermined range may be changed depending on the distance to the target or a reflectance of the target and is previously stored in storage section 140, arid by setting an optimum predetermined range according to the distance to the target and the reflectance, it can be expected that the accuracy in measuring the distance to the feature point is improved.

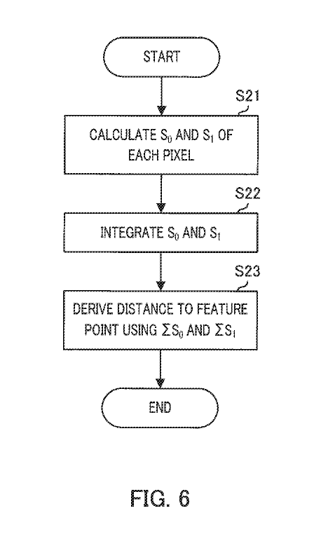

Another example of the distance measurement processing performed in step S3 will be described in detail with reference to the flowchart of FIG. 6. In the above-described example, the distance to the feature point is derived by performing the arithmetic mean after the distance to the target from the pixel corresponding to the feature point and the distance to the target from the pixel located around the pixel corresponding to the feature point are derived. In contrast to this, in the example which will be described below, the distance to the feature point is derived by integrating the return light components of the pixels corresponding to the feature point and pixels around the pixels corresponding to the feature point and by using the integrated return light components.

In step S21, distance measurer 120 calculates return light components S₀ and S₁ of the pixel corresponding to the feature point and the pixel located around the pixel corresponding to the feature point by using equations 2 and 3 described above, by using a depth image signal. In this case, adopting only information of the pixels included in the clustered region is the same as in the example described above.

In subsequent step S22, distance measurer 120 integrates return light components S₀ and S₁ of the pixel corresponding to the feature point and the pixel located around the pixel corresponding to the feature point, thereby, obtaining integration values ΣS₀ and ΣS₁ of the return light components.

In subsequent step S23, distance measurer 120 derives distance cit to the feature point by using following equation 5.

dt={c×Wa}/2}×(ΣS₁/ΣS₀) (5)

Returning to the description of FIG. 3, in step S4 subsequent to step S3, identifier 130 calculates three-dimensional coordinates of the respective feature points by using the distances to the respective feature points derived in step S3. As described above, the processing of step S4 may be performed by distance measurer 120.

In step S5 subsequent to step S4, identifier 130 identifies a posture and a motion of a driver based on the three-dimensional coordinates of the respective feature points. For example, a posture for gripping a steering wheel with both hands may be previously set as a basic posture, and the posture of the driver may be identified based on the change from the basic posture. Regarding the basic posture, for example, in a case where the posture of grasping the steering wheel with both hands is detected, the posture may be set as the basic posture.

In addition, for example, the posture and motion of the driver may be identified based on a change from a previous posture. Furthermore, for example, the posture and motion of the driver may be identified by storing coordinates of feature points in a case where the driver performs various motions in advance in storage section 140 and by comparing the stored coordinates with the calculated coordinates.

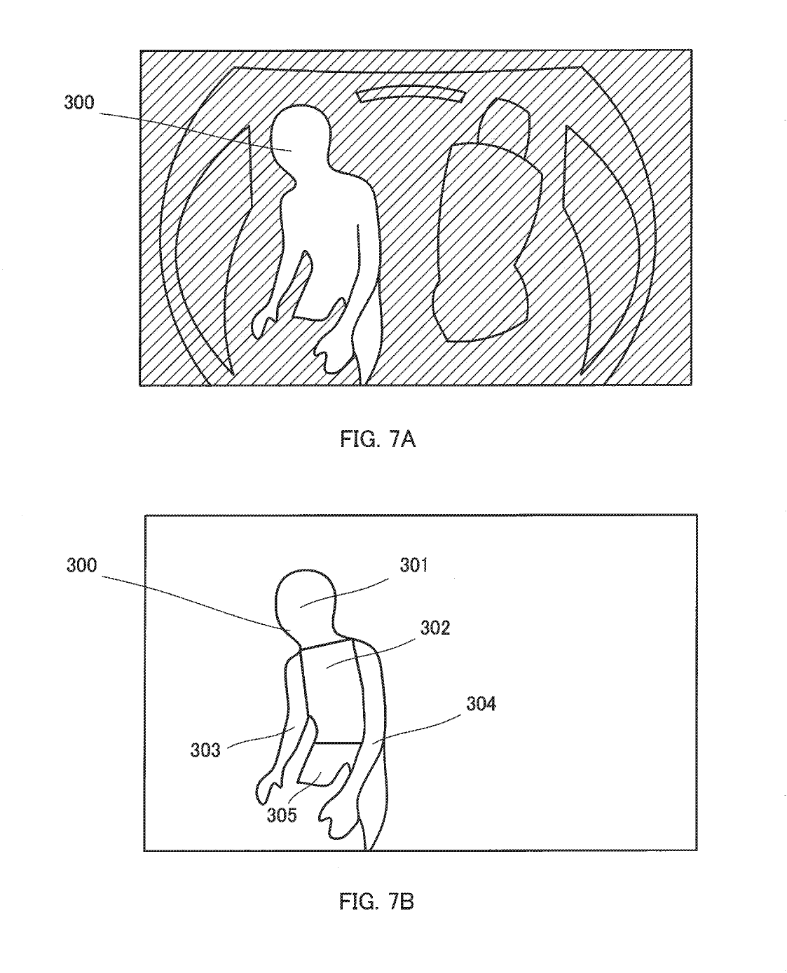

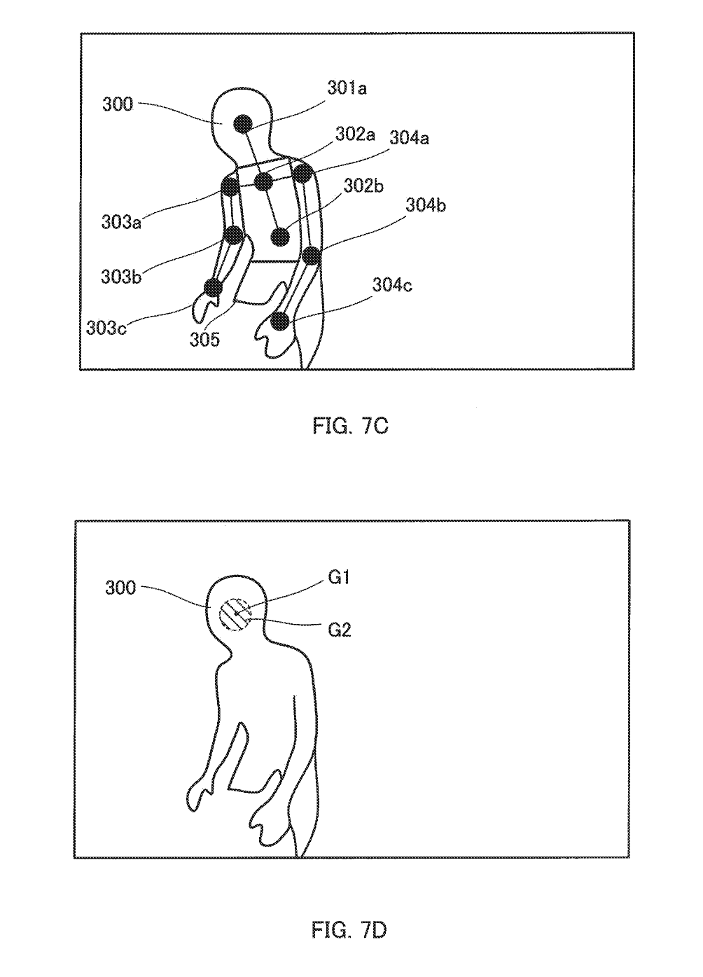

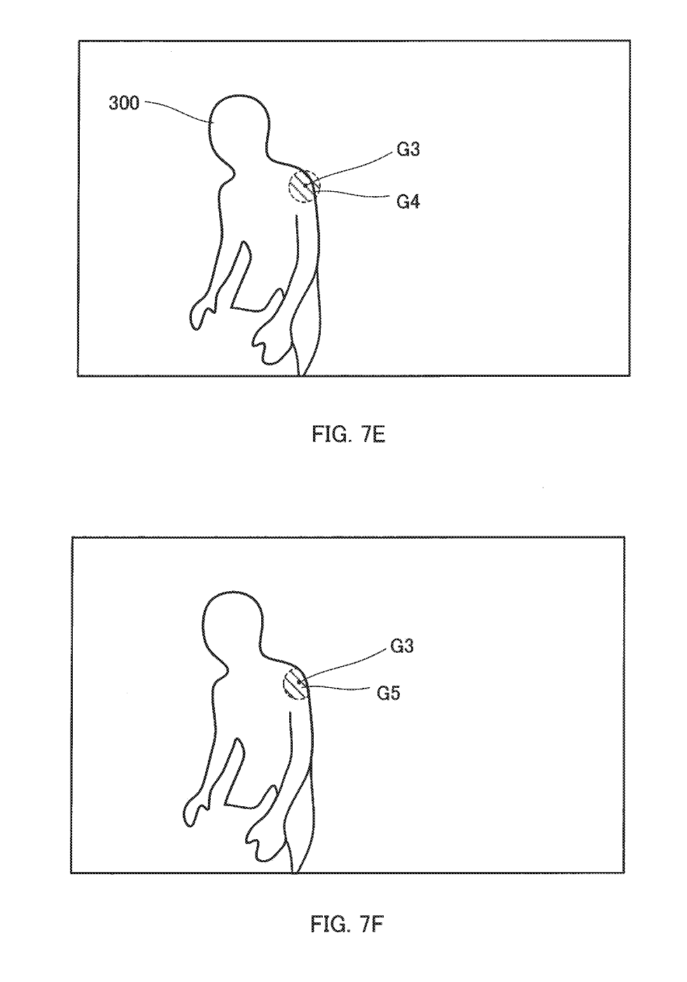

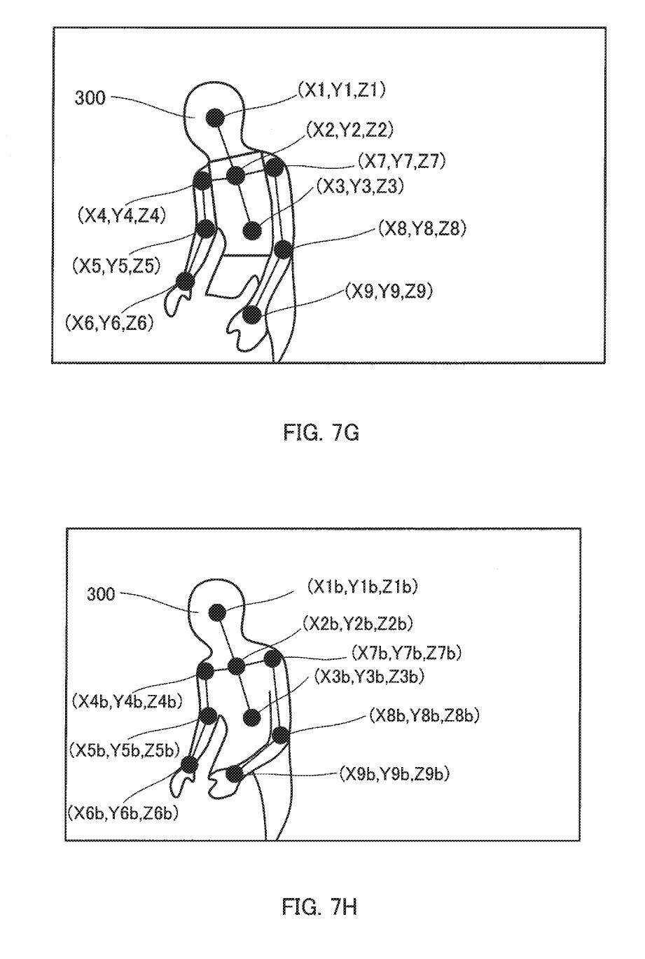

Next, a specific example of identifying a posture of an occupant in a moving object according to Embodiment 1 will be described with reference to FIGS. 7A to 7H.

FIG. 7A schematically illustrates a distance image of an internal space of a vehicle captured by the imaging apparatus. In the distance image, a region (region which is not hatched) corresponding to driver 300 sitting in a driver's seat becomes “a region where a distance from the imager is substantially constant”. Therefore, distance measurer 120 extracts the region where the distance from the imager is substantially constant and clusters the region. In the present example, a region corresponding to driver 300 in the distance image illustrated in FIG. 7A is clustered.

After the region corresponding to driver 300 is clustered, distance measurer 120 divides (site division) the clustered region into respective sites of head portion 301, motion body portion 302, right arm portion 303, left arm portion 304, and lower body portion 305.

FIG. 7B illustrates a case Where driver 300 is subjected to the site division. The site division can be performed, for example, by comparing a human body model previously stored in storage section 140 with the clustered region.

After the clustered region is divided into the respective sites, distance measurer 120 assigns feature points (feature point assignment) to the respective sites of head portion 301, motion body portion 302, right arm portion 303, left arm portion 304, and lower body portion 305 according to a predetermined rule. The feature points may be assigned to a skeleton location or the like.

FIG. 7C illustrates the assigned feature points. In the example illustrated in FIG. 7C, feature point 301a is assigned to head portion 301. In addition, feature point 303a is assigned to a site corresponding to the right shoulder of right arm portion 303, feature point 303b is assigned to a site corresponding to the right elbow, and feature point 303c is assigned to a site corresponding to the right wrist. In addition, feature point 304a is assigned to a site corresponding to the left shoulder of left arm portion 304, feature point 304b is assigned to a site corresponding to the left elbow, and feature point 304c is assigned to a site corresponding to the left wrist.

In addition, feature points 302a and 302b are assigned to motion body portion 302. In the present example, feature point 302a is a midpoint of a straight line connecting feature point 303a assigned to the site corresponding to the right shoulder to feature point 304a assigned to the site corresponding to the left shoulder.

Feature point 302b is assigned to a portion spaced apart from feature point 302a by a predetermined distance in a direction opposite to feature point 301a. How to assign the feature points is not limited to the above-described example. It is a matter of course that the feature point may be not only a skeleton feature point around a joint portion determined based on the skeleton in consideration of movement of a joint and the like hut also a feature point that is not based on the skeleton, such as a surface of clothes.

Subsequently, distance measurer 120 derives a distance to each feature point. In the present example, derivation of the distance to feature point 301a of head portion 301 and the distance to feature point 304a of left arm portion 304 will be described in detail, and detailed description on derivation of the distance to the other feature points will be omitted.

The derivation of the distance to feature point 301a will be described with reference to FIG. 7D. Distance measurer 120 determines pixel group G2 existing within a predetermined range from pixel G1 corresponding to feature point 301a of head portion 301.

Pixel group G2 exists within a region of head portion 301. Therefore, distance measurer 120 derives a distance to a target in pixel G1 and distances to targets in the respective pixels included in pixel group G2, performs an arithmetic mean of the distances, and derives the distance to the feature point 301a.

Next, referring to FIGS. 7E and 7F, derivation of a distance to feature point 304a will be described. Distance measurer 120 determines pixel group G4 existing within a predetermined range from pixel G3 corresponding to feature point 304a of left arm portion 304 (FIG. 7E).

Pixel group G4 includes pixels outside a region of left arm portion 304 in addition to the pixels existing in the region of left arm portion 304. Therefore, distance measurer 120 extracts only the pixels existing in the region corresponding to driver 300 from pixel group G4, and sets the pixels as pixel group G5 (FIG. 7F).

Then, the distance to the target in pixel G3 and the distance to the target in each pixel included in pixel group G5 are derived, an arithmetic mean is performed for the distances, and thereby, the distance to feature point 304a is derived. In a case where intensity of the return light is high, such as a case where the reflectance of the target is high, or a case where the distance to the feature point is short, and in a case where a sufficient distance accuracy is obtained, it is a matter of course that addition processing of pixels around the pixel corresponding to the feature point need not be performed.

Subsequently, identifier 130 calculates three-dimensional coordinates of the respective feature points based on the distances to the respective feature points derived by distance measurer 120 (FIG. 7G).

In the example illustrated in FIG. 7G, the three-dimensional coordinates of feature point 301a are (X1, Y1, Z1). In addition, the three-dimensional coordinates of feature point 302a are (X2, Y2, Z2). In addition, the three-dimensional coordinates of feature point 302b are (X3, Y3, Z3).

In addition, the three-dimensional coordinates of feature point 303a are (X4, Y4, Z4). In addition, the three-dimensional coordinates of feature point 303b are (X5, Y5, Z5). In addition, the three-dimensional coordinates of feature point 303c are (X6, Y6, Z6).

In addition, the three-dimensional coordinates of feature point 304a are (X7, Y7, Z7). In addition, the three-dimensional coordinates of feature point 304b are (X8, Y8, Z8). In addition, the three-dimensional coordinates of feature point 304c are (X9, X9, Z9).

Meanwhile, the three-dimensional coordinates ((X1b, Y1b, Z1b), (X2b, Y2b, Z2b), . . . , (X9b, Y9b, Z9b)) of the respective feature points for a posture (refer to FIG. 7H) for gripping a steering wheel with both hands are stored in storage section 140.

Identifier 130 compares the three-dimensional coordinates of the respective calculated feature points with the three-dimensional coordinates of the respective feature points in the basic posture stored in storage section 140, thereby, identifying the posture and motion of the driver.

In the example illustrated in FIG. 7G, the three-dimensional coordinates (X9, Y9, Z9) of feature point 304c are greatly different from the three-dimensional coordinates (X9b, Y9b, Z9b) of the feature point 304c in the basic posture. Accordingly, identifier 130 identifies that the driver separates the left arm from the steering wheel to operate an audio apparatus.

As described above, according to the present embodiment, the distance to the feature point of the driver in an internal space of a vehicle captured by the imaging apparatus is derived by using the TOF method. Then, based on the distance to the derived feature point, a posture of the driver is identified.

Thereby, it is possible to accurately identify the posture of the driver.

In addition, according to the present embodiment, since the distance to the feature point is derived by using information on the feature point and the respective pixels around the feature point, an accuracy in measuring a distance is improved. Accordingly, it is possible to accurately estimate the posture of the driver.

Furthermore, according to the present embodiment, since the distance to the feature point is derived by using information on the respective pixels included in the feature point, a periphery thereof, and the clustered region, a distance accuracy is improved. Accordingly, it is possible to accurately estimate the posture of the driver.

### Embodiment 2

In Embodiment 1 described above, a region corresponding to a driver is extracted from an infrared image or a distance image, and a feature point is assigned according to a predetermined rule.

In contrast to this, in Embodiment 2 which will be described below, machine learning on a feature point is previously performed by using an image of a driver to which a feature point is assigned, and the feature point is assigned by using a learning result thereof.

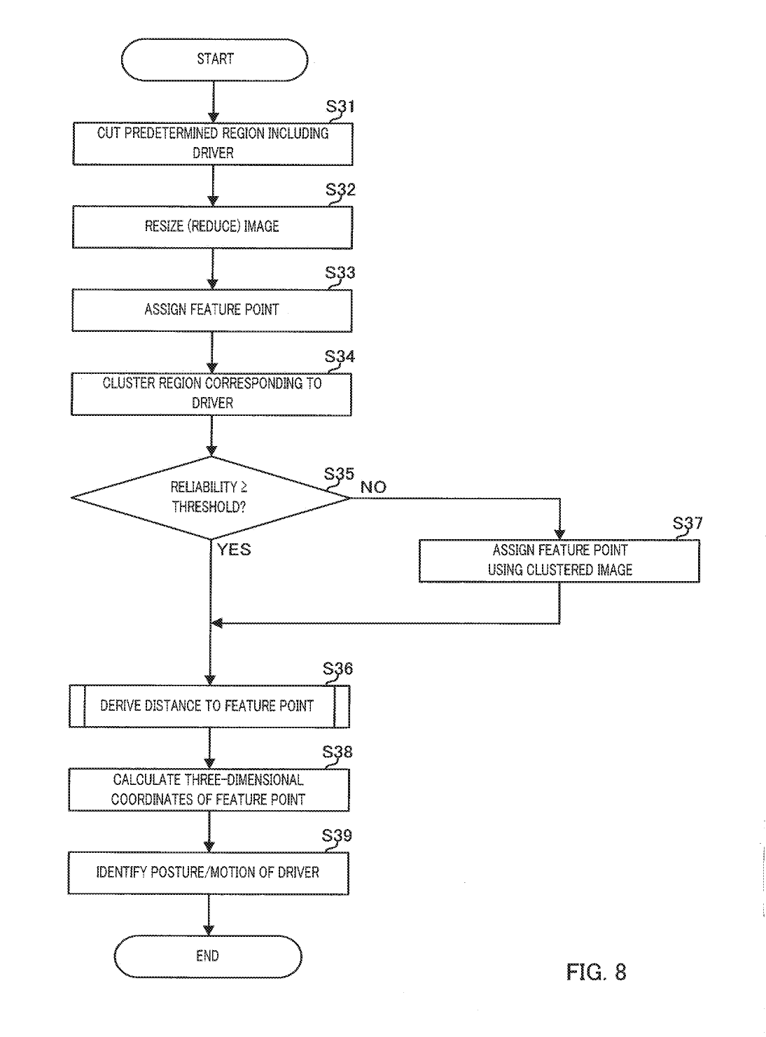

Embodiment 2 of the distance measurement processing and the identification processing performed by distance measurer 120 and identifier 130 of identification apparatus 100 will be described in detail with reference to a flowchart of FIG. 8.

In step S31, distance measurer 120 cuts a predetermined region including a driver from an infrared image or a distance image received from image sensor 220.

In subsequent step S32, distance measurer 120 resizes (reduces) the image cut in step S31.

In subsequent step S33, distance measurer 120 compares the image resized in step S32 with a learning result obtained by machine learning, and assigns a feature point to the resized image. At this point, a reliability (details will be described below) regarding the feature point is also assigned.

A size of the image of the driver used for the machine learning is also the same as a size of the image resized in step S32. Accordingly, it is possible to reduce a calculation load of the machine learning, and to reduce the calculation load in step S33.

In subsequent step S34, distance measurer 120 extracts a region corresponding to the driver by using the infrared image or the distance image received from image sensor 220, and clusters the region.

In subsequent step S35, distance measurer 120 determines whether or not the reliability regarding the feature point assigned in step S33 is higher than or equal to a predetermined threshold.

In step S35, in a case where it is determined that the reliability is higher than or equal to the threshold (step S35: YES), the processing proceeds to step S36.

In step S36, distance measurer 120 derives a distance to each feature point by using the TOF method. For deriving the distance to the feature point, the image received from the image sensor 220 (the image used for clustering) is used as it is, instead of the resized image (image used for assigning the feature point). Since processing content of step S36 is the same as the processing content of step S3 according to Embodiment 1, a detailed description thereof will be omitted.

Meanwhile, if it is determined that the reliability is not higher than or equal to the threshold (step S35: NO) in step S35, the processing proceeds to step S37.

In step S37, distance measurer 120 estimates a feature point such as a skeleton location by using the image clustered in step S34 as in step S2 according to Embodiment 1, and the processing proceeds to step S36.

In a case where the reliability regarding the feature point is low, there is a risk that the feature point is actually assigned to a location that is not the feature point. Accordingly, if subsequent processing is performed based on the feature points with low reliability as described above, there is a risk that the posture and motion of the driver is erroneously identified in the identification processing.

In contrast to this, in the present example, in a case where the reliability regarding the feature point is low, the feature point is re-assigned according to a preset rule by using the clustered image. Accordingly, it is possible to prevent the posture and motion of the driver from being erroneously identified.

In step S38 subsequent to step S36, identifier 130 calculates three-dimensional coordinates of the respective feature points by using the distances to the respective feature points derived in step S36. The calculation of the three-dimensional coordinates may be performed by distance measurer 120 as in Embodiment 1 described above.

In step S39 subsequent to step S38, identifier 130 identifies the posture and motion of the driver based on the three-dimensional coordinates of the respective feature points. Since processing contents of steps S38 and S39 are the same as the processing contents of steps S4 and S5 according to Embodiment 1, a detailed description thereof will be omitted.

Next, a specific example of assigning the feature points according to Embodiment 2 will be described with reference to FIGS. 9A to 9C.

FIG. 9A schematically illustrates a distance image of an internal space of a vehicle captured by the imaging apparatus.

Distance measurer 120 cuts a predetermined region including driver 400 from the distance image in an imaging range (FIG. 9B). In addition, distance measurer 120 resizes the cut region. In the present example, as an example, it is assumed that the number of pixels in the imaging range is 640 pixels×480 pixels, the number of pixels in the cut region is 384 pixels×480 pixels, and the number of pixels after resizing is 96 pixels×120 pixels. That is, since the image is resized to ¼, the number of pixels is one sixteenth.

Meanwhile, at this point, machine learning which uses an image having a size cut and resized in the imaging range is previously performed, and a learning result thereof is stored in storage section 140.

Distance measurer 120 compares the resized image with the learning result stored in storage section 140, and assigns a feature point to the resized image. At this time, by using the resized image, it is possible to greatly reduce a computational load as compared with using an image not resized. FIG. 9C illustrates a state in which skeletal joints (head, neck, waist, right shoulder, right elbow, right wrist, left shoulder, left elbow, and left wrist) of the driver are thus assigned as feature points.

As described above, according to Embodiment 2, since the machine learning is performed by using the reduced image, the calculation load in machine learning can be reduced. In addition, when a distance to a feature point is derived, an image that is not cut and resized is used, and thus, it is possible to suppress degradation of an accuracy in measuring the distance. Furthermore, when the distance to the feature point is derived, information on a pixel corresponding to the feature point and information on pixels around the pixel are used, and thus, it is possible to improve the accuracy in measuring distance. Furthermore, in a case where the reliability of the feature point assigned by the machine learning is log the feature point assigned by the machine learning is not used and the feature point is reassigned by using the captured image, and thus, it is possible to preferably prevent the accuracy in measuring the distance from decreasing.

While various embodiments have been described herein above, it is to be appreciated that various changes in form and detail may be made without departing from the spirit and scope of the invention(s) presently or hereafter claimed.

This application is entitled to and claims the benefit of Japanese Patent Application No. 2018-031789, filed on Feb. 26, 2018, the disclosure of which including the specification, drawings and abstract is incorporated herein by reference in its entirety.

### INDUSTRIAL APPLICABILITY

According to the identification apparatus, the identification method, and the non-transitory tangible recording medium storing the identification program, in the present disclosure, it is possible to accurately identify the posture of the occupant of the moving object, which is suitable for on-vehicle use.

### REFERENCE SIGNS LIST

1 Driver monitoring system (DMS)
100 Identification apparatus
110 imaging controller
120 Distance measurer
130 Identifier
140 Storage section
200 Imaging apparatus
210 Light source
220 Image sensor

1. An identification apparatus that identifies a posture of an occupant of a moving object, the identification apparatus comprising:
a distance measurer that determines a feature point of the occupant based on an infrared image or a distance image each obtained by an imaging apparatus, and derives a distance to the feature point by using a time of flight distance measurement method; and
an identifier that identifies the posture of the occupant based on the distances to a plurality of the feature points.

2. The identification apparatus according to claim 1, wherein the distance measurer derives the distance to the feature point based on information of a pixel corresponding to the feature point and respective pixels corresponding to a surrounding region of the feature point.

3. The identification apparatus according to claim 2, wherein the distance measurer derives distances to the occupant from the pixel corresponding to the feature point and from the respective pixels corresponding to the surrounding region of the feature point by using the time of flight distance measurement method, and calculates the distance to the feature point by performing an arithmetic mean of the distances to the occupant corresponding to the derived respective pixels.

4. The identification apparatus according to claim 2, wherein the distance measurer integrates return light components of the pixel corresponding to the feature point and the respective pixels corresponding to the surrounding region of the feature point, and derives the distance to the feature point by using the time of flight distance measurement method based on an integration value of the return light components.

5. The identification apparatus according to claim 2, wherein the distance measurer clusters a region including the occupant and derives the distance to the feature point by using pixels that are included in the clustered region, among the respective pixels corresponding to the surrounding region.

6. The identification apparatus according to claim 1, wherein the distance measurer clusters a region including the occupant and determines the feature point based on information of the clustered region.

7. The identification apparatus according to claim 6, wherein the distance measurer performs a site division on the clustered region, and determines the feature point based on information on respective sites resulting from the site division.

8. The identification apparatus according to claim 1, wherein the distance measurer determines the feature point by using information on the feature point which is obtained by machine learning.

9. The identification apparatus according to claim 8, wherein the distance measurer determines the feature point by using an image obtained by performing at least one of cutting and reduction on the infrared image or the distance image.

10. The identification apparatus according to claim 9, wherein the distance measurer clusters a region including the occupant, and determines a new feature point based on information of the clustered region in a case where reliability of the determined feature point is low.

11. An identification method for identifying a posture of an occupant of a moving object, the method comprising:
determining a feature point of the occupant based on an infrared image or a distance image each obtained by an imaging apparatus, and deriving a distance to the feature point by using a time of flight distance measurement method; and
identifying the posture of the occupant based on the distances to a plurality of the feature points.

12. A non-transitory tangible recording medium storing therein an identification program causing a computer to execute processing comprising:
determining a feature point of the occupant based on an infrared image or a distance image each obtained by an imaging apparatus, and deriving a distance to the feature point by using a time of flight distance measurement method; and
identifying the posture of the occupant based on the distances to a plurality of the feature points.

13. The identification apparatus according to claim 1, wherein the identifier calculates three-dimensional coordinates of the feature point by using the distance to the feature point, and identifies the posture of the occupant based on the three-dimensional coordinates.

14. The identification apparatus according to claim 13, wherein the identifier identifies the posture of the occupant based on a change of the calculated three-dimensional coordinates of the feature point.

15. The identification apparatus according to claim 14, wherein the identifier identifies the posture of the occupant based on the change of the calculated three-dimensional coordinates of the feature point from three-dimensional coordinates of the feature point in a preset basic posture.

16. The identification apparatus according to claim 14, wherein the identifier identifies the posture of the occupant based on a comparison between the calculated three-dimensional coordinates of the feature point and three-dimensional coordinates of the feature point in a predetermined posture which is previously stored.
